(19) United States
(12) Patent Application Publication
(10) Pub. No.: US 2006/0109876 A1
(43) Pub. Date: May 25, 2006

(54) METHOD AND SYSTEM FOR COMBINING MULTIPLE LASER BEAMS USING TRANSMISSION HOLOGRAPHIC METHODOLOGIES

(75) Inventors: John Donoghue, South Boston, MA (US); Mark Andrews, Brookline, MA (US)

Correspondence Address: DIGITAL OPTICS TECHNOLOGIES, INC., 1645 HICKS ROAD, SUITE A, ROLLING MEADOWS, IL, 60008, US

(73) Assignee: Selim M Shahriar, Rolling Meadows, IL (US)

(21) Appl. No.: 10/904,669

(22) Filed: Nov. 22, 2004

(51) Int. Cl. H01S 3/13; H01S 3/08

(52) U.S. Cl. 372/32; 372/102

(57) ABSTRACT

The Holographic Beam Combiner, (HBC), is used to combine the output from many lasers into a single-aperture, diffraction-limited beam. The HBC is based on the storage of multiple holographic gratings in the same spatial location. By using a photopolymer material such as quinone-doped polymethyl methacrylate (PMMA) that uses a novel principle of “polymer with diffusion amplification” (PDA), it is possible to combine a large number (N) of diode lasers, with an output intensity and brightness 0.9 N times as much as those of the combined outputs of individual N lasers. The HBC will be a small, inexpensive to manufacture, and lightweight optical element. The basic idea of the HBC is to construct multiple holograms onto a recording material, with each hologram using a reference beam incident at a different angle, but keeping the object beam at a fixed position. When illuminated by a single read beam at an angle matching one of the reference beams, a diffracted beam is produced in the fixed direction of the object beam. When multiple read beams, matching the multiple reference beams are used simultaneously, all the beams can be made to diffract in the same direction, under certain conditions that depend on the degree of mutual coherence between the input beams.

### GOVERNMENT INTERESTS

GOVERNMENT RIGHTS STATEMENT: This invention was made with government support under contract F29601-00-C-0084 and F29601-01-C-0015 awarded by the US Air Force. The government has certain rights in the invention.

### Reference Cited

U.S. PATENT DOCUMENTS

| | | |
|---|---|---|
| 6,263,126 | Jul. 17, 2001 | Cao |
| 6,256,321 | Jul. 3, 2001 | Kobayashi |
| 6,005,8611 | Feb. 21, 1999 | Humpleman |
| 6,256,308 B1 | Jul. 3, 2001 | Carlsson |
| 5,999,5181 | Feb. 7, 1999 | Nattkemper et a.l. |
| 6,043,914 | Mar. 28, 2000 | Cook et al. |
| 6,263,130 B1 | Jul. 17, 2001 | Barnard |
| 6,211,978 B! | Apr. 3, 2001 | Wojtunik |

### RELATED U.S. APPLICATIONS DATA

Provisional application No. 60/563,824

### OTHER PUBLICATIONS

Coupled Wave Theory for Thick Hologram Gratings; The Bell System Technical Journal: Herwig Kogelnik, Vol. 48, No. 9, November 1969

Cascaded Coupled Mach-Zehner Channel Dropping Filters for Wavelength-Division-Multiplexed Wavelength-Division Multiplexed Optical Systems; Journal of Lightwave Technology: M. Kuznetsov, Vol. 12, No. 2, February 1994

Silica-Based Integrated Optical Frequency-Division-Multiplexing Distribution Systems With Optical Tunable Filters; Journal on Selected areas in Communications: H. Toba, et al: vol SAC-4, No. 9 December 1986

Ramanathan et al., “Home Network Controller: A Cost-Effective Method for Providing Broadband Access to Residential Subscribers”, International Conference on Consumer Electronics—Digest of Tech. Papers, Rosemont, Jun. 7-9, 1995. IEEE, pp 378-379, Jul. 6, 1995

Alvarez, “Integrating business and residential PONs”, Lightwave, July 2001, pp 102-106

Sharer, “Fiber-optic Ethernet in the local loop”, Lightwave, July 2001, pp 96-100

Smits, “Unifying the access network with fiber”, Lightwave, July 2001, pp 88-94

Martin, “Beyond inaccessible network access”, Lightwave, July 2001, pp 84-86

Hanson, “Access networks: Looking back suggests what's ahead”, Lightwave, July 2001, pp 77-82

Schuller et al., “Extending reliability and survival optical rings to the access network”, Lightwave, July 2001, pp 120-127

### BACKGROUND OF THE INVENTION

The present invention relates to combining the outputs of multiple laser beams that serve a wide range of uses, including military and space applications such as high power, high brightness sources for medium and short range ladars, high energy laser based anti-missile defensive weapons, for over-the-air optical communications and for fiber based optical telecommunications applications.

Holography is a technique for recording and later reconstructing the amplitude and phase distribution of a coherent wave disturbance. Generally, the technique utilized for producing a holographic element is accomplished by recording the pattern of interference between two optical beams or waves. Historically, holography was developed for displaying three-dimensional images, with the very first development by the inventor, Dennis Gabor, to be used as a lensless camera. The waves, one reflected from an object, called the object wave and a second that bypasses the object is called the reference wave, are used to record the information in light sensitive recording medium, such as a holographic film or plate.

To employ holograms for laser beam combining involves using two laser sources, called an object bream and a reference beam, both generated by lasers. Several alternative techniques exist for combining laser beams, however each has its limitations and none exist that have the ability to successfully combine large numbers of lasers (10 or more). It should be noted that the technique used for beam combining is reversible, by changing the direction of combined beams, thus combining and separation can be accomplished with the same optical devices. The following are three techniques that are most commonly used:

Incoherent beam combining using polarizing beam-splitters. With this approach, a conventional polarizing beam-splitter is used to combine beams. This method is illustrated in FIG. 1.a a polarizing beam splitter 5 is generally used to split the beam based on the beams directions of polarization. FIG. 1a shows the beam being split into the TM (transverse magnetic) mode 6 and the TE (transverse electric) mode 6. As a beam combiner it is used in reverse to combine the TE mode 6 from one with the TE mode 6 of the other as shown in FIG. 1b. However, this process can combine only two lasers of different polarization modes effectively, the combined beam has multiple directions of polarization and would not be able to be cascaded to combine again in this fashion. Additionally, birefringence induced depolarization would cause the output to fluctuate. If a non-polarized beam is used, the process is cascadable, but the coupling efficiency falls off rapidly with increased stages because only one polarization mode can be combined from each beam.

Coherent beam combining via phase locking. If the lasers are phase locked, in principal many can be combined coherently using a set of beam splitters with differing splitting ratios. In practice, this approach is very complicated and fragile, and is incompatible with combining inexpensive, independent diode lasers.

Thin grating based beam combining—In this approach, several beams can be combined by matching each of the dominant diffraction indices in a blazed grating. However, in order to prevent loss of coupling efficiency in the desired direction, the input lasers have to be apart in wavelength by 1 nm typically, thus limiting the number of lasers for a practical application. For example, in the case of an EDFA pump at 980 nm, the pump gain window is only 8 nm wide. As such, only 4 lasers can be combined, yielding a pump power of about 1 Watt. For such applications, EDFA powers of 10 Watts or more are required, thus this combining method is not a viable solution for the application.

### BRIEF SUMMARY OF THE INVENTION

The basic idea of the holographic beam combiner (HBC) is to use volume transmission gratings to combine a chosen number of laser sources into one beam. The invention can be employed using two different methods, as we will describe. The two methods are the following: 1. Beam combining using single-grating independent holograms 2. Beam combining using multiple-grating holograms

Each method has its own advantages and tradeoffs. First we will summarize combining using single grating independent holograms. The concept is illustrated in FIG. 2a. A single-grating transmission hologram 7 is used here to combine the two beams into one beam as shown. In combining the two beams 3a-3b, beam one 3a is transmitted through the hologram 7 with little loss. Beam two 3b is diffracted by the hologram 7 in such a way to be collinear with beam one, hence combining the beams into the combined beam 2. The hologram 7 used here is created by recording a holographic grating into the recording material as illustrated in FIG. 2b. Two plain wave beams 3a-3b are directed onto the recording material 8 to record such a grating. In doing so, the incident angles, exposure times and intensity must be carefully chosen.

Using this method, many beams can be combined by using several single-grating holograms 7 as is illustrated in FIG. 3. Each hologram 7 used combines an additional laser beam by diffracting it to be collinear with the existing beam that transmits through the hologram 7. Using this method, n number of beams can be combined using n−1 number of single-grating holograms 7.

Beam combining can also accomplished using multiple-grating holograms. This method reduces the number of optical components used in the combining and also reduces the fresnel reflections losses. However, it also has much stricter incident angle and wavelength requirements. The basic concept used in combining is illustrated in FIG. 4a. Here, several beams 3 are combined using a single optical component known as the multiple-grating hologram 1 or a Holographic Beam Combiner. The hologram contains several gratings, each one diffracting one of the beams to be collinear as is illustrated. Such a hologram can be recorded by writing several holographic gratings into a recording material as illustrated in FIG. 4b. Each grating must be recorded individually, and the angles must be carefully chosen so that the diffracted beams are all directed along the same path.

In both methods of single grating and multiple grating combining, both mutually coherent and mutually incoherent beams can be combined. Theoretically, diffraction efficiencies approaching 100% for each beam individually. In practice, impurities in the material will reduce the diffraction efficiencies to less than 100%, however with superior fabrication methodologies, efficiencies in excess of 90% have been attained and with extreme efforts it is possible to approach the theoretical upper limit with optically pure materials.

The present invention relates to combining lasers that can be coherent (of the same wavelength) or incoherent (of different wavelengths) in a manner that is superior to alternative techniques using blazed gratings and other techniques. For coherent combinations, the input lasers have to be degenerate in frequency. For incoherent combinations, the input lasers are non-degenerate, differing in wavelengths by Δλ, which is dependent on the thickness of the holographic recording media. The ability to combine large numbers of coherent and incoherent lasers allows constructing optical power sources made up of numerous low powers, low cost semiconductor lasers that find applications in civilian, military and space applications, telecommunications and a wide range of industrial applications.

Solving the obstacles of writing multiple gratings in the same volume is the first step in creating holograms useful for multiple beam combining using multiple-grating holograms. The second consideration is to use a light sensitive recording media that has an inherently high diffraction efficiency, (approaching 100%), is sensitive over a wide range of frequencies, (ideally from 488 nm to 2000 nm), is stable over time and is insensitive to environmental influences over the temperatures ranges that will be encountered. The maximum index modulation, M#, a parameter that has a typical value of 1 for most permanent thick holograms, will accommodate the writing of one highly efficient hologram. To write 20 highly efficient holograms in the same volume, an M# of 20 or higher is required. Through the selection of the holographic medium, the control of the dye used in the manufacturing process, the mixing and heat treatment of the molded photopolymer material, and the quality control of the impurities that contaminate the material is part of the process for insuring that the photopolymer used for making high channel count beam combiners will result in holograms of the desired quality.

Many photopolymers may be utilized for storing holographic images, and the novel writing and reading techniques described herein will work with other materials. For purposes of disclosing this invention, the specific photopolymer discussed below is used. The material that is described in this invention application utilizes quinone-doped polymethyl methacrylate (PMMA) with a material parameter corresponding to the maximum index modulation (M# 20) that has efficiencies greater than 90% in each beam. This polymeric material uses a novel principle of “polymer with diffusion amplification”, or PDA. The material can readily withstand power intensities of up to 180 W/sq. cm without a drop in efficiency. This is the equivalent to being able to transfer 111 Kwatt of radiated laser energy utilizing a PMMA delivery geometry with an area of an 8½ by 11 inch sheet of paper. The HBC is scalable and the area the size of nine 8½ by 11 inch sheets of paper (841.5 sq. inches) will have the ability to transfer 1 Mw of laser power without a drop in efficiency. The energy transfer system is scalable and higher levels of power transfer are possible so long as the power intensities of the PDA material are not exceeded.

With conventional high index refraction lenses, the beams can be focused to achieve extremely high-energy concentrations within an area of a few square centimeters. As the source of the laser power can be multiple small low cost un-cooled diode lasers, the high-energy devices that can be built utilizing the HBC technology can also be small and transportable. The breakthrough of being able to build small, un-cooled transportable or portable high-energy sources will open many new applications for the HBC technology.

For applications that depend on high stability of the laser sources, such as WDM applications, frequency locking is essential to avoid drifting that contributes to channel instability and loss of diffraction efficiency. The present invention utilizes a novel method for locking the frequencies of a plurality of laser beams, through an optical feed back methodology that is ultra stable relative to current art, that creates an individual feedback loops with each laser source through a single optical element.

To reach laser power levels of tens, hundreds, or thousands of watts of power output and higher, large numbers of low cost, low power semiconductor lasers may be used. The most effective means for combining them is to use cascading of two or more stages of combined laser sources and groups of combined laser sources. This method of cascading is illustrated in FIG. 11. The cascading shown here is essentially an extension of the multiple-grating beam combining as previously described. Here, several beams 3 that are already combined beams can be further combined. For example, by starting with an easily manageable number of 25 lasers in the first stage, feeding into a second stage of say 20 first stage units and a third stage of 20 second stage units, a combined output with the total of 25×20×20 or 10,000 lasers sources, less minor losses contributed by holographic material. If each laser has a power of 50 mw, the resultant output will be 10,000×0.05×0.9×0.9×0.9 or 364.5 W, assuming an efficiency of 0.9 for each cascaded stage.

The holograms that are created with the present invention can operate in two directions. For WDM applications, both multiplexing and demultiplexing for a given wavelength or family of wavelengths can be accomplished with the same module. The modules can then serve as multiplexers or de-multiplexers. For example, a mirror image of the cascaded combiner shown in FIG. 11 could be used subsequently branch each individual laser back out from the combined beam 2. In WDM applications this is important to be able to distinguish each wavelength as a separate channel.

Conventional laser sources have single output levels that are determined by the inherent lasing level of the semiconductor material or gaseous properties (in the case of gas lasers) of the lasing material. With the HBC technology, the continuous output power can be controlled by adjusting the number of input laser sources that are contributing to the output at any given time, thus providing a highly accurate, vernier control of output. Control can be accomplished by arranging the powering source to be controlled singly or in groups of the input lasers so that selected combinations can give a continuous adjustment in the output power, over the desired controllable range. Applications such as laser eye surgery or internal artery laser plaque removal that requires extremely high stability, accuracy and output control will be satisfied by the HBC technology.

### BRIEF DESCRIPTION OF THE DRAWINGS

FIG. 1 is an illustration of beam combining using a polarizing beam splitter

FIG. 2 is an illustration of combining two lasers using a single-grating independent hologram

FIG. 3 is an illustration of combining many lasers using multiple single-grating independent holograms.

FIG. 4 is a schematic illustration of a holographic beam combiner diffracting incoming laser beams at different angles, to a single, output beam using a multiple-grating hologram;

FIG. 5 is a schematic illustration of the geometry for writing two holograms at 532 nm. The angles of the writing beams are chosen to ensure that when these holograms are read by lasers at 980 nm, the output beams will overlap.

FIG. 6 is a schematic illustration of the geometry for reading the two holograms, the first one at 9a at 980 nm and the second one 9b at 980 nm+

FIG. 7 is a table of calculated writing angles for producing the beam combiner

FIG. 8 is a schematic illustration demonstrating the process for writing 9 holograms to combine the beams mentioned in FIG. 7

FIG. 9 is an illustration of the writing set-up for the Holographic Beam Combiner

FIG. 10 is a schematic illustration of a of the feedback geometry to be employed in combining lasers to lock in the intended Bragg wavelength

FIG. 111 is a schematic illustration of a typical cascade stage of a multi-stage transmission Holographic Beam Combiner

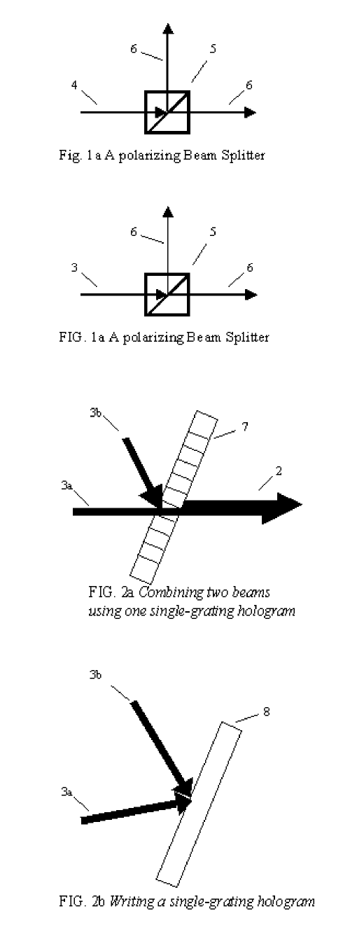

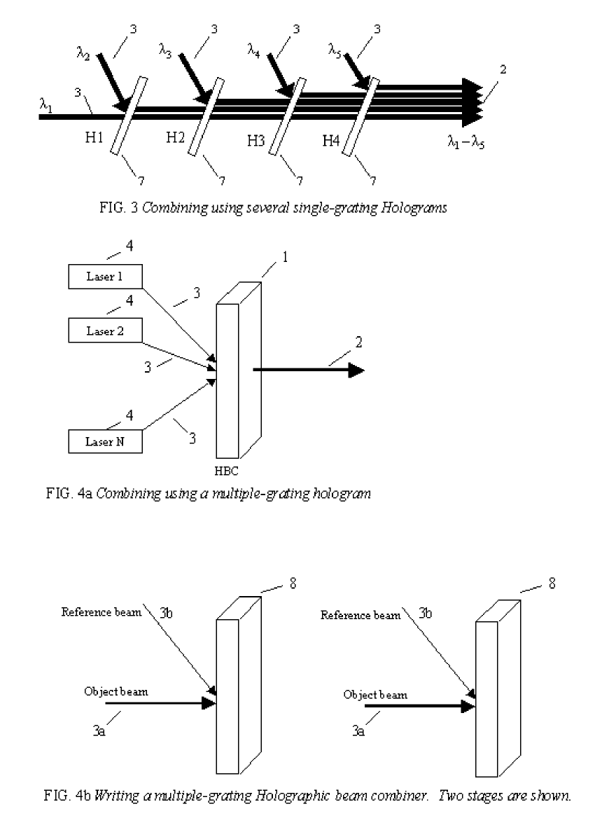

### DETAILED DESCRIPTION OF THE INVENTION

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiments shown, but is to be accorded the widest scope consistent with the principles and features described herein.

This description will focus on combining using multiple-grating holograms, although it should be noticed that this also encompasses the methods for combining using single-grating holograms.

In order to fully understand the embodiments of this invention, it is first necessary to describe the technique for writing and reading a single holograms onto a holographic substrate and then in writing multiple holograms onto the same substrate, thus creating a the holographic beam combiner (HBC). There are two key elements necessary to produce high channel count holographic beam combiners, a) the process for writing and reading a large number of holograms in a given volume of the storage medium and b) the recording medium used to store the holograms. Though there are many choices for the holographic storage medium and the writing and reading methodology will work for any recording material, for illustration purposes, this invention disclosure utilizes a photo sensitive polymer, polymethyl methacrylate (PMMA) that has been doped with a small percentage of dye (phenanthraquinone), that results in a process called post-diffusion amplification (PDA), hereinafter referred to as PDA photopolymer. This material has been manufactured to our specifications for the related research and development of this invention, meeting stringent standards for refractive index, bandwidth sensitivity, power density, dye concentration and other parameters that are necessary for reliably storing multiple holograms in the same volume. The holographic writing and reading process of this invention can be applied to many holographic substrate materials with the results described herein, giving consideration to the variable material related factors that are discussed below.

Reference will now be made in detail to the present preferred embodiments of the invention, examples of which are illustrated in the accompanying drawings, wherein like reference numeral indicate like elements through the several views.

Reference is made to FIG. 4, to describe the basic idea behind the holographic beam combiner. This diagram in FIG. 4a depicts a plurality of low power laser beams 3 impinging on the HBC 1 at various angles from the left side of the diagram. The Bragg grating formed within the HBC effectively redirects these incident beams so that there is one high power, high brightness, diffraction limited output beam exiting as a single composite beam 2 from the right side of the HBC 1

The recording of this multiple grating hologram can be described simply for the case where the writing wavelengths and reading wavelengths are the same. As shown in FIG. 4b, the multiple-grating hologram 1 is written in stages, each stage writes one of the gratings necessary for combining. Two stages are illustrated here, to record the gratings needed to combine beams 1 3a and beams 2 3b along the intended path. The model shown here is simplified for the case where the recording wavelength is the same as the wavelength that will be used. For this case, the gratings are each written by using a reference beam 3b incident at a different angle, while keeping the object beam at a fixed position. When illuminated by a single read beam at an angle matching one of the reference beams, the diffracted beam is produced in the fixed direction of the object beam as shown. When multiple read beams, matching the multiple reference beams, are used simultaneously, all of the beams can be made to diffract in the same direction, under certain conditions that depend on the degree of mutual coherence between the input beams. This can also be seen in reverse. For example, if the output beam were re-directed back by 180°, the individual beams would diffract back through the HBC at the same angle that they entered the HBC.

In most useful cases, the recording wavelength will be different than the wavelength actually combined. In these cases, the writing angles incident on the HBC must be calculated using Bragg theory. This will be discussed further in detail.

When the combined beams are mutually incoherent, it is necessary to ensure that the wavelengths of the neighboring input lasers differ by an amount greater than the wavelength selectivity bandwidth of each grating. The wavelength selectivity is determined by the read angles used, the grating periodicity, and the thickness of the hologram used. For mutually coherent beams that are degenerate in frequency, it is necessary to control the relative phases and amplitudes of the input beams in order to produce a single combined beam. In this case, the diffraction efficiency of each individual grating is much less (when combining a large number of beams) than the overall diffraction efficiency, defined as the ratio of the single output beam intensity to the sum of the input intensities. There are obstacles to realizing this concept for useful applications, primarily due to material limitations.

In order to ensure that the HBC 1 does not get damaged as the result of the high concentration of the multiple input beams, care must be taken to limit the output power density to below 180 W/cm², for the PMMA material used. This can be done by expanding the beam diameter with conventional optic lenses.

Most photopolymers are sensitive only to a certain range of wavelengths for recording. However, they can be used at a much wider range of wavelengths. The PDA photopolymer is no exception. For recording, the photopolymer is best recorded at wavelengths near 500 nm to 540 nm. Typically an Argon-ion laser (514.5 nm) or a Nd:YAG laser (532 nm) are used. Once the gratings are recorded, the grating can be useful at a much larger range of wavelengths up to 2000 nm. However, changing the wavelength used, also changes the Bragg angle where diffraction occurs. This angle to wavelength condition, known as the Bragg's law can be expressed using the following equation:

$$cos {θ}_{B} = \frac{λ}{2 Λ}$$

Where Λ is the grating periodicity of the grating, θ_{B} is the incident angle, and λ is the wavelength where the Bragg condition occurs. The following analysis describes how this relationship can be used to write gratings at different wavelengths from which they are used for combining.

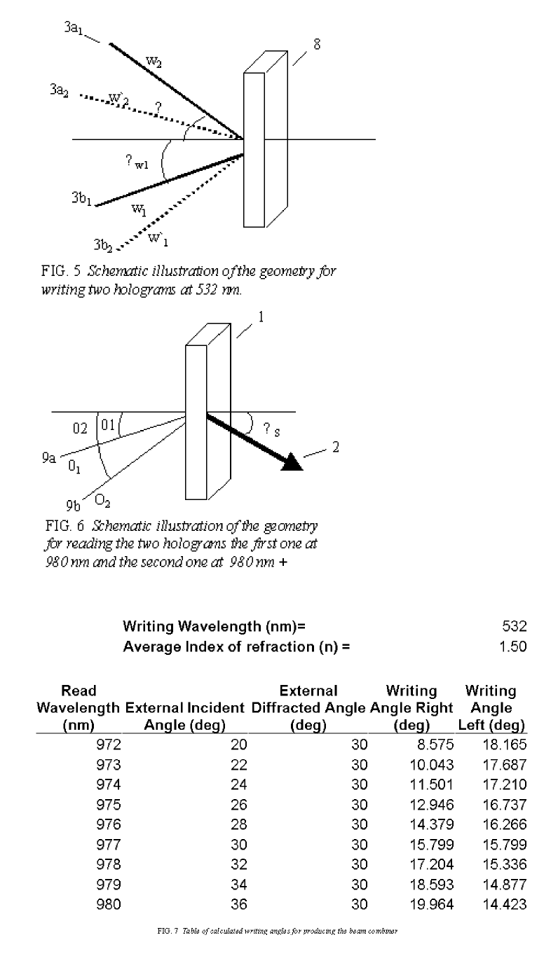

Reference is made to FIG. 5 that is a schematic of geometry for writing two holograms 8 at 532 nm, the specific example values chosen for discussion purposes. The objective is to write an HBC that can combine two lasers that are each at a wavelength near 980 nm. The first step in this process is to choose a set of writing angles for the writing wavelength of 532 nm. A summary of the analysis is:

FIG. 5 shows the basic writing geometry. Consider first the process for writing the first hologram; using beams W₁ 3b (reference) and W₂ 3a (object), using laser beams of wavelength 532 nm. We choose these two beams to be symmetric with respect to the axis (perpendicular to the face of the HBC 1) normal to the PDA substrate 1. If read by a laser beam at 532 nm, the read beam will diffract efficiently only if it is Bragg matched, i.e., incident at exactly the same angle as, for example, the object beam (W₂) 3a, and produce a diffracted beam on the other side parallel to the reference beam (W₁) 3b. However, when read by a laser beam O₁ at 980 nm, as shown in FIG. 6, the Bragg incidence angle as well as the diffracted angle (θ_{S}) would be larger. Consider next the process for writing the second hologram, using a new pair of beams at 532 nm: W′₁ 3b and W′₂ 3a, as shown in FIG. 5. The goal is to choose the directions for these two beams to be such that when this hologram is read by a laser beam O₂ 9b (see FIG. 6) at a wavelength of (980 nm+Δλ), where Δλ is to be chosen by us, the diffracted beam will come out at the same angle θ_{S}.

In designing these angles, the first step is to choose a value of the common diffraction angle, θ_{S}, fix the writing wavelength to be 532 nm, and choose the wavelength for the first read beam O₁ 9a, to be exactly 980 nm (i.e., Δλ₁=0). This determines the first pair of writing angles, θ_{w1} and θ_{w2}. We then choose the value of δ, the angular distance between the first 9a and the second read beams 9b (see table of FIG. 7), as well as the wavelength of the second read beam, O₂ 9b. These constraints yield a new pair of writing angles, θ′_{w1} and θ′_{w2}, for the beams W′₁ 3b and W′₂ 3a, respectively, in FIG. 5. Explicit analysis shows that these angles are given by:

$$[ {θ}_{W1} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] - \tilde{δ} / 2 \} ] ] \\ [ {θ}_{W2} = {Sin}^{- 1} [ {n}_{W} \cdot Sin \{ {Sin}^{- 1} [ \frac{{n}_{R}}{{n}_{W}} \cdot \frac{{λ}_{W}}{{λ}_{R}} \cdot Sin ( {\tilde{θ}}_{S} + \tilde{δ} / 2 ) ] + \tilde{δ} / 2 \} ] ]$$

Where we have defined:

$$[ {\tilde{θ}}_{S} = {Sin}^{- 1} ( \frac{Sin {θ}_{S}}{{n}_{R}} ) ] \\ [ \tilde{δ} = {Sin}^{- 1} ( \frac{Sin ( {θ}_{S} + δ )}{{n}_{R}} ) - {Sin}^{- 1} ( \frac{Sin {θ}_{S}}{{n}_{R}} ) ]$$

$$\begin{matrix}δ ≡ ( Read Angle at {λ}_{W} ) - ( Read Angle at 980 nm ) \\ {n}_{W} ≡ index at the writing wavelength \\ {n}_{R} ≡ index at the reading wavelength \\ {λ}_{W} ≡ the writing wavelength \\ {λ}_{R} ≡ the reading wavelength\end{matrix}$$

These equations are used as follows:
STEP 1: Choose a fixed value for θ_{S} (e.g., π/3)
STEP 2: Choose a fixed value for λ_{W} (e.g., 532 nm)
STEP 3: Determine the symmetric pair of writing angles, θ_{w1} and θ_{w2}, which correspond to the case of λ_{R}=980 nm, and δ=0
STEP 4: Choose a new value of δ (e.g., 50 mrad) and a new value of λ_{R} (e.g. 981 nm), which yield a new pair of writing angles
STEP 5: Repeat step 4 for every new pair of writing angles necessary

It should be noted that these equations take into account the effect of holographic magnification when the read wavelength is longer than the writing wavelength, and the effect of potentially different indices of refraction.

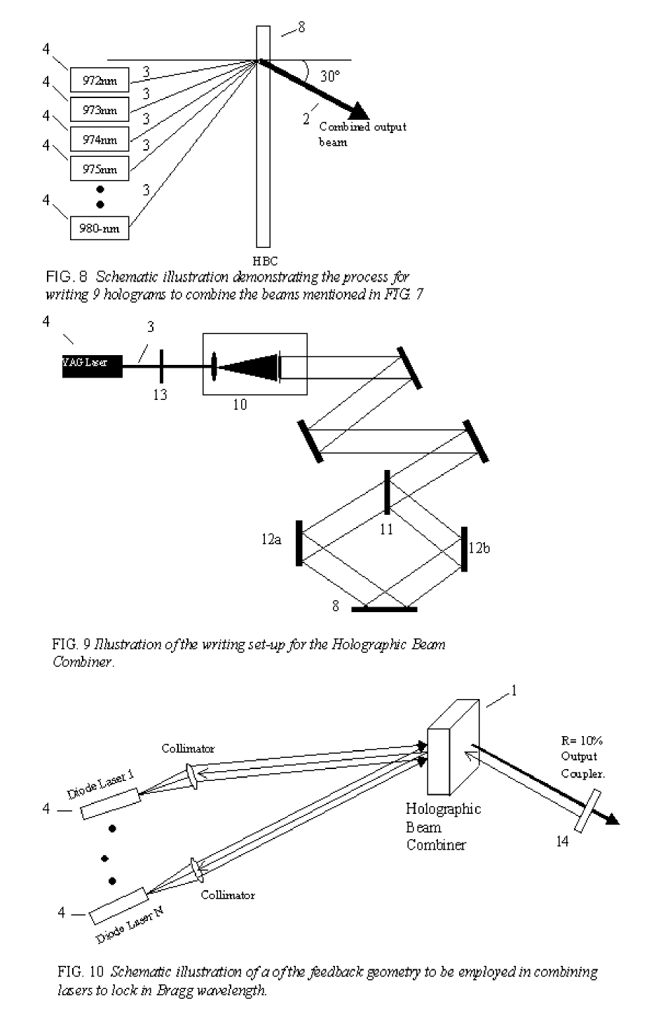

Reference is made to FIG. 8 that is a schematic illustration of a process for writing N holograms 1, where for purposes of explaining the process, N=9. The composite output beam exits at the right of the HBC and input beams enter on the left with an incident angle of from 20° to 36°, in increments of 1 nm, The nine orthogonal gratings are to be written in a way so that each one will diffract only one of the input lasers to the fixed output direction. The orthogonality is ensured by the wavelength separation between the neighboring lasers (1 nm [symbol] ≈455 GHz), which is larger than the spectral bandwidth (≈150 GHz) in the transmission geometry shown here, for a sample thickness of 2 mm. The output beams are to emerge at an angle of 30°, superimposed on one another, with a nearly 9-fold increase in brightness. Though this example is for nine beams, the number can be 10 or many times higher.

The gratings necessary for this purpose were written in a single substrate using a Nd:YAG laser at 532 nm with a power of 200 mW. The difference between the read and the writing wavelenghts makes it necessary to calculate the writing angles with precision, using a closed form of expression. This calculation also takes into account the differing angles of refraction at the different wavelengths, due to differing indices. Table 1 in FIG. 7 shows these writing angles, corresponding to the writing geometry shown in FIG. 5. The angles are given in decimal degrees, followed by an unmarked column where the values are expressed in degrees, minutes, and seconds. These unmarked columns are used during the writing, since the rotation stages are market in these units.

Reference is made to FIG. 9 that is a schematic illustration of a writing set-up for making holograms on a holographic substrate 1. Using this setup, single-grating or multiple-grating holograms can be written. The HBC can be created by using the writing angles as previously calculated. In this case, the Nd:YAG laser is first expanded by a beam expander 10. The expanded beam is then directed through a series of mirrors to the 50/50 beam splitter 11, splitting it into two expanded beams of equal intensity. Mirrors 12a and 12b direct each of the split beams onto the holographic substrate. The appropriate angles are found by mounting the hologram and the final mirrors on appropriate rotation stages. Though the specific example uses an N of nine, N can be a large number limited only by the physical characteristics of the holographic media utilized. A shutter 13 is inserted in the path of the YAG laser beam so that the correct exposure time can accurately be used during the writing process. The writing process for multiple holograms is done by changing the angles of the two mirrors 12a, 12b to angles that have been calculated through the process described. The exposure time can be adjusted in order to produce the most efficient hologram for the application. Finding the optimal exposure time depends on many factors including the intensity of the writing laser, the photosensitivity of the holographic material, the writing angles used, and the index modulation required to maximize the efficiency at the appropriate wavelength of use. For the particular set-up describe herein, this time ranges from 700 seconds using a 200 mW laser to approximately 70 seconds for a 2 W laser.

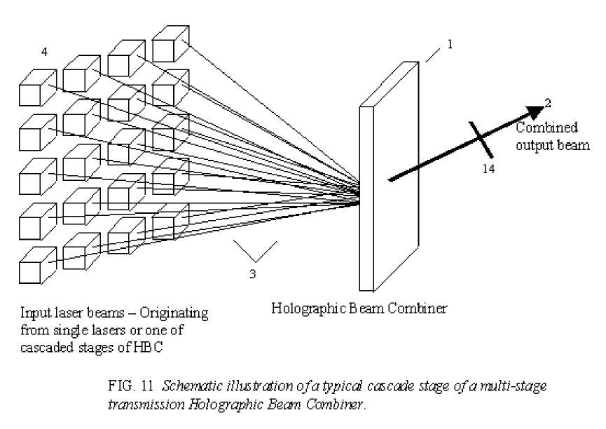

Reference is made to FIG. 10 that is a schematic illustration of the feedback configuration used in combining lasers that are multimode both spatially and temporarily. Briefly, N holograms would be recorded in a single substrate 1, using typically an argon ion laser at 514.5 nm 4. The angles would be chosen so that during the readout by N non-degenerate lasers (at around 980 nm, for example) the diffracted beams would overlap. A problem may arise in that laser diodes may shift their output wavelength as their wavelength is related to its temperature. One way to control this is to use temperature controllers to keep the temperature stable. There are also instances when the output of the laser may be multimode and therefore the spectrum may be larger than the spectral selectivity of the combining grating.

This problem will be eliminated in the presence of the feedback, as illustrated in FIG. 10. Briefly, the front facet of each laser will be anti-reflective (AR) coated, and the diffracted beams will be reflected back (from 5 to 10%) with a partial reflecting mirror (the output coupler) 14. As such, the lasing cavity for each laser would be formed by its high-reflecting back facet, and the output coupler. Because only a specific frequency (determined by the Bragg conditions) would be diffracted and reflected back efficiently for a given laser, each laser will automatically tune and lock to the one desired wavelength.

Reference is made to FIG. 11 that is a schematic illustration of a typical cascade stage of a multi-stage transmission HBC. This configuration depicts typical arrangement where N laser beams 3 can be combined into a HBC 1, with the output 2 directed to a second stage may then be combined further through a multi-stage cascading arrangement. This diagram shows 20 laser sources being combined. In this configuration, the feedback mirror 15 with a 5 to 10% reflection, is inserted into the combined output beam 2, and will lock the individual frequencies of each of the 20 laser sources.

In this cascaded combining, the wavelengths of the combined beams must be carefully chosen. For incoherent cascaded combining, it is necessary that each combined beam out of the first stage of combining must have spectral characteristics within some Δλ wavelength range so that this entire beam can be diffracted by a single grating. Furthermore, each of these combined beams out of the first stage of combining must be separated by Δλ to avoid unwanted diffraction and to keep the combined beams spectrally distinct. For this reason, the HBC used in the second stage of cascaded combining must have a larger wavelength selectivity in order to diffract the entire spectral width of the already combined beams. In order to get the second stage HBC to have a larger window of wavelength selectivity, a thinner sample must be used

With this background, it can now be shown how low power laser beams can be combined in a cascaded fashion to reach extremely high output power levels. Consider that the lasers that are combined are 1 watt each and there is an efficiency of 90% per cascaded stage. If there are three cascaded staged of 20 combined sources per stage, this would result in (20×1 W×0.9)×(20×0.9)×(20×0.9)=5,832 watts. Observing the thermal limits of PMMA of 180 W/cm² (other holographic material that may be used will have a different thermal limit) would require an area of 32.4 sq cm for a final stage of approximately 6 cm by 6 cm to handle this level of laser power. To scale up to hundreds of kilowatts or megawatts would require observing the same thermal limit constraints and designing the output beam density to remain within the acceptable limits. Based on these parameters, one Mwatt of power can be handled by an area of 75 cm by 75 cm.

What is claimed is:

1. A method & system comprising: means for generating a plurality of laser beams at multiple frequencies; and providing a stable, all optic feedback control so as to lock the frequencies of the plurality of laser beams.

2. A method & system comprising: a plurality of stages of laser sources cascading two or more stages of laser sources so as to generate laser beams that are combined using in each stage a single holographic substrate containing multiple gratings in order to reach at least ten watts of power output.

3. A method & system according to claim 2, wherein the combined beam to reach at least hundred watts of power output.

4. A method & system according to claim 2, wherein the combined beam to reach at least thousand watts of power output.

5. A method & system comprising: a plurality of N laser sources and (N−1) individual holographic gratings in a cascaded arrangement so as to yield a single combined laser beam with at least ten watts of power output.

6. A method & system according to claim 5, wherein the combined beam to reach at least hundred watts of power output.

7. A method & system according to claim 5, wherein the combined beam to reach at least thousand watts of power output.
